(19) United States
(12) Patent Application Publication
(10) Pub. No.: US 2009/0304899 A1
(43) Pub. Date: Dec. 10, 2009

(54) BIRD FEED THAT ATTRACTS LESS BLACKBIRDS AND OTHER UNDESIRABLE BIRDS

(75) Inventor: Bruce Augustin, Marysville, OH (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: OMS INVESTMENTS, INC., Los Angeles, CA (US)

(21) Appl. No.: 12/481,390

(22) Filed: Jun. 9, 2009

Related U.S. Application Data
(60) Provisional application No. 61/060,077, filed on Jun. 9, 2008.

(51) Int. Cl. A23K 1/18

(52) U.S. Cl. 426/630

(57) ABSTRACT

The invention relates to a bird feed mixture that is intrinsically unattractive to undesirable birds such as blackbirds, cowbirds or grackles. The bird feed mixture attracts less undesirable birds while still attracting larger numbers of desirable song birds such as, for example, finches. The bird feed mixture contains nyjer (thistle), safflower, black oil sunflower, peanut, white millet, sunflower chips, canary seed, raisin, red millet, and juniper berries.

### CROSS-REFERENCE TO RELATED APPLICATIONS

This application claims the benefit under 35 U.S.C. § 119(e) to U.S. Provisional Application Ser. No. 61/060,077, filed Jun. 9, 2008, the entire disclosure of which is hereby incorporated by reference.

### BACKGROUND OF THE INVENTION

(a) Field of the Invention

The invention relates to bird feed mixtures for repelling blackbirds and other large birds.

(b) Description of the Related Art

Bird watching enthusiasts seek to provide food to attract bird species that are talented singers, colorful, rare or that possess other desirable characteristics. A common problem is that the food provided to attract desirable bird species may be consumed by non-bird species or undesirable bird species, such as blackbirds. For example, the problem of marauders consuming food intended for desirable food species is discussed in U.S. Pat. No. 4,144,842. Undesirable larger birds, such as blackbirds, can consume large quantities of bird feed at great expense to the bird watching enthusiast. Additionally, the presence of large, undesirable birds has a tendency to frighten off smaller, more desirable song birds.

Devices for discriminating against undesirable birds such as blackbirds and other marauding species are known to the art. U.S. Pat. No. 4,144,842 discloses a bird feeder mechanism that limits access to the feed area by adjusting the distance between a protective hood and the rim of a feed pan of the bird feeder such that only birds below a certain size can access the feed area. U.S. Pat. No. 5,445,109 discloses a bird feeder employing a spring-based mechanism that denies access to bird feed to undesirable birds and other species that weigh more than a given maximum weight. U.S. Pat. No. 4,996,947 discloses a bird feeder that requires birds to feed while hanging upside down, thereby selecting for goldfinches while excluding other bird species that are not able to feed while upside down.

Bird feeds and other compositions have also been designed to repel particular species. U.S. Pat. No. 5,821,269 discloses a bird seed treated with capsaicin, capsaicin derivatives or analogs thereof in an amount sufficient to be unpalatable to animals having capsaicin sensitive receptors. U.S. Patent Application Publication No. 2005/0186237 discloses a bird repellent composition.

While these and other methods known in the art select against undesirable birds, there is still a need for a bird feed mixture that is intrinsically unattractive to undesirable birds. Such a bird feed mixture would decrease the number of undesirable birds attracted to a bird feeder without regard to the type of bird feeder mechanism used to dispense the food.

### BRIEF SUMMARY OF THE INVENTION

In one aspect, the invention provides a defined bird feed mixture that is intrinsically unattractive to undesirable birds such as blackbirds and other large birds. In another aspect, the invention provides a defined bird feed mixture that decreases the number of undesirable birds that visit and eat from a bird feeder.

In another aspect, the invention provides a defined bird feed mixture of Nyjer (thistle), safflower, black oil sunflower, peanut, white millet, sunflower chips, canary seed, raisins, red millet and juniper berries. In another aspect, the invention provides for a container, item or package comprising a defined mixture of Nyjer (thistle), safflower, black oil sunflower, peanut, white millet, sunflower chips, canary seed, raisins, red millet and juniper berries. In yet another aspect, the invention provides for a method for producing bird seed comprising combining Nyjer (thistle), safflower, black oil sunflower, peanut, white millet, sunflower chips, canary seed, raisins, red millet and juniper berries.

In another aspect, the invention provides a method for repelling birds comprising supplying the bird feed mixture of the invention.

### BRIEF DESCRIPTION OF THE DRAWINGS

FIG. 1 is a diagram of bird feeders at a testing station that have been arranged into two “Homes” for the testing of bird's preferences for control formula bird feed mixture versus a mixture of 20% nyjer (thistle), 18% safflower, 10% black oil sunflower, 10% peanut, 8% white millet, 8% sunflower chips, 8% canary seed, 8% raisin, 6% red millet and 4% (hereinafter “MCB mixture”).

FIG. 2 is an exemplary view of different types of bird feeder designs that are available for use.

FIG. 3 is a chart showing the results of a side-by-side survey comparing preferences of undesirable birds and desirable birds for the control formula bird feed versus the MCB mixture.

FIG. 4 is a chart showing the results of sequential surveys comparing the preferences of undesirable birds and desirable birds for the control formula bird feed versus the MCB mixture.

FIG. 5 is a chart showing the amounts of control formula bird feed and MCB mixture bird feed consumed during sequential surveys comparing the preferences of undesirable birds and desirable birds for the two bird feed mixtures.

FIG. 6 is a chart showing the results of a second side-by-side survey comparing preferences of undesirable birds and desirable birds for the control formula bird feed versus the MCB mixture.

FIG. 7 is a chart showing the average number of blackbirds seen during experimental observation periods for MCB formulations optimized for (1) attracting the highest number of non-blackbirds, (2) creating the highest ratio of non-blackbirds to blackbirds, and (3) attracting the lowest number of blackbirds.

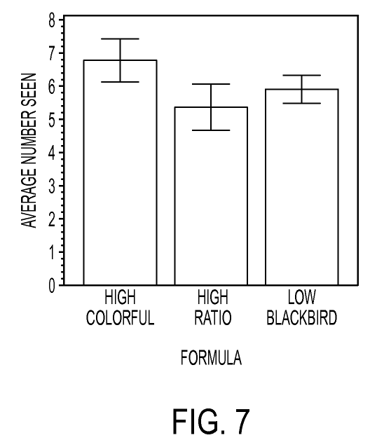

FIG. 8 is a chart showing the average number of non-blackbirds seen in during experimental observation periods for MCB formulations optimized for (1) attracting the highest number of non-blackbirds, (2) creating the highest ratio of non-blackbirds to blackbirds, and (3) attracting the lowest number of blackbirds.

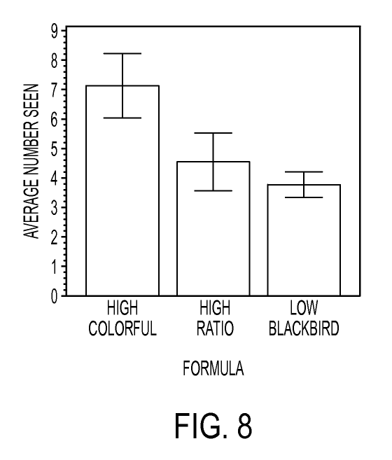

FIG. 9 is a chart showing the average ratio of non-blackbirds to blackbirds seen during experimental observations period for MCB formulations optimized for (1) attracting the highest number of non-blackbirds, (2) creating the highest ratio of non-blackbirds to blackbirds, and (3) attracting the lowest number of blackbirds.

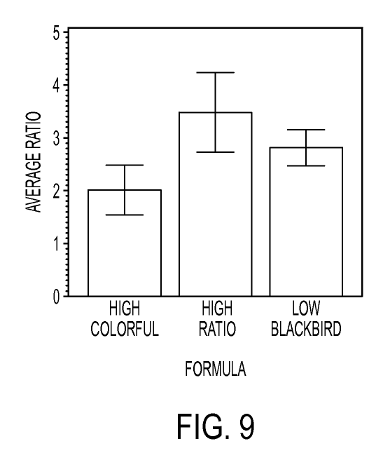

### DETAILED DESCRIPTION OF THE PREFERRED EMBODIMENTS

The invention relates to a defined bird feed mixtures for repelling blackbirds and other large birds. In one embodiment, the invention relates to a bird feed mixture consisting essentially of various amounts of nyjer (also referred to as “thistle”), safflower, black oil sunflower, peanut, white millet, sunflower chips, canary seed, raisins, red millet, and juniper berries.

The bird feed mixture of the invention has the surprising and advantageous property of being unattractive to birds, such as blackbirds, that are undesirable to bird watching enthusiasts. The bird feed mixture of the invention contains fewer ingredients that are preferred by grackles, cowbirds and blackbirds than are found in commercially available bird feed mixtures. As a result, fewer of these undesirable birds and more desirable birds, such as sparrows, finches, chickadees, titmice, and woodpeckers, visit bird feeders filled with the bird feed mixture of the invention.

In one aspect, the bird feed mixture comprises about 0.1 to 30% nyjer (thistle), 0.1 to 30% safflower, 0.1 to 20% black oil sunflower, 0.1 to 15% peanut, 0.1 to 15% white millet, 0.1 to 20% sunflower chips, 0.1 to 15% canary seed, 0.1 to 15% raisin, 0.1 to 10% red millet, and 0.1 to 10% juniper berry by weight. More preferably, the bird feed mixture comprises about 10 to 30% nyjer (thistle), 9 to 27% safflower, 5 to 15% black oil sunflower, 5 to 15% peanut, 4 to 12% white millet, 4 to 12% sunflower chips, 4 to 12% canary seed, 4 to 12% raisin, 3 to 9% red millet, and 2 to 6% juniper berry by weight. Even more preferably, the bird feed mixture comprises about 15 to 25% nyjer (thistle), 14 to 22% safflower, 7 to 13% black oil sunflower, 7 to 13% peanut, 6 to 10% white millet, 6 to 10% sunflower chips, 6 to 10% canary seed, 6 to 10% raisin, 4 to 8% red millet, and 3 to 5% juniper berry by weight. Even more preferably, the bird feed mixture comprises about 18 to 22% nyjer (thistle), 16 to 20% safflower, 9 to 11% black oil sunflower, 9 to 11% peanut, 7 to 9% white millet, 7 to 9% sunflower chips, 7 to 9% canary seed, 7 to 9% raisin, 5 to 7% red millet, and 3 to 5% juniper berry by weight.

In one aspect, the bird feed mixture consists essentially of about 0.1 to 30% nyjer (thistle), 0.1 to 30% safflower, 0.1 to 20% black oil sunflower, 0.1 to 15% peanut, 0.1 to 15% white millet, 0.1 to 20% sunflower chips, 0.1 to 15% canary seed, 0.1 to 15% raisin, 0.1 to 10% red millet, and 0.1 to 10% juniper berry by weight. More preferably, the bird feed mixture consists essentially of about 10 to 30% nyjer (thistle), 9 to 27% safflower, 5 to 15% black oil sunflower, 5 to 15% peanut, 4 to 12% white millet, 4 to 12% sunflower chips, 4 to 12% canary seed, 4 to 12% raisin, 3 to 9% red millet, and 2 to 6% juniper berry by weight. Even more preferably, the bird feed mixture consists essentially of about 15 to 25% nyjer (thistle), 14 to 22% safflower, 7 to 13% black oil sunflower, 7 to 13% peanut, 6 to 10% white millet, 6 to 10% sunflower chips, 6 to 10% canary seed, 6 to 10% raisin, 4 to 8% red millet, and 3 to 5% juniper berry by weight. Even more preferably, the bird feed mixture consists essentially of about 18 to 22% nyjer (thistle), 16 to 20% safflower, 9 to 11% black oil sunflower, 9 to 11% peanut, 7 to 9% white millet, 7 to 9% sunflower chips, 7 to 9% canary seed, 7 to 9% raisin, 5 to 7% red millet, and 3 to 5% juniper berry by weight.

In another aspect, the bird feed mixture comprises about 0.1 to 30% nyjer (thistle), 0.1 to 30% safflower, 0.1 to 20% black oil sunflower, 0.1 to 15% peanut, 0.1 to 15% white millet, 0.1 to 20% sunflower chips, 0.1 to 15% canary seed, 0.1 to 15% raisin, 0.1 to 10% red millet, and 0.1 to 10% juniper berry by weight, wherein the bird feed mixture does not contain any other types of seeds or fruits. More preferably, the bird feed mixture comprises about 10 to 30% nyjer (thistle), 9 to 27% safflower, 5 to 15% black oil sunflower, 5 to 15% peanut, 4 to 12% white millet, 4 to 12% sunflower chips, 4 to 12% canary seed, 4 to 12% raisin, 3 to 9% red millet, and 2 to 6% juniper berry by weight, wherein the bird feed mixture does not contain any other types of seeds or fruits. Even more preferably, the bird feed mixture comprises about 15 to 25% nyjer (thistle), 14 to 22% safflower, 7 to 13% black oil sunflower, 7 to 13% peanut, 6 to 10% white millet, 6 to 10% sunflower chips, 6 to 10% canary seed, 6 to 10% raisin, 4 to 8% red millet, and 3 to 5% juniper berry by weight, wherein the bird feed mixture does not contain any other types of seeds or fruits. Even more preferably, the bird feed mixture comprises about 18 to 22% nyjer (thistle), 16 to 20% safflower, 9 to 11% black oil sunflower, 9 to 11% peanut, 7 to 9% white millet, 7 to 9% sunflower chips, 7 to 9% canary seed, 7 to 9% raisin, 5 to 7% red millet, and 3 to 5% juniper berry by weight, wherein the bird feed mixture does not contain any other types of seeds or fruits. The bird feed mixture of the present invention does not include a bird feed mixture of about 20% nyjer (thistle), 18% safflower, 10% black oil sunflower, 10% peanut, 8% white millet, 8% sunflower chips, 8% canary seed, 8% raisin, 6% red millet, and 4% juniper berry by weight (MCB mixture).

The bird feed mixtures of the present invention do not include a bird feed mixture of about 20% nyjer (thistle), 18% safflower, 10% black oil sunflower, 10% peanut, 8% white millet, 8% sunflower chips, 8% canary seed, 8% raisin, 6% red millet, and 4% juniper berry by weight (MCB mixture).

Each of the components of the bird feed mixture of the invention are well known components and are readily available.

The bird feed mixture of the invention may be placed in a container, item or package. For example, the bird feed mixture may be packaged for commercial availability.

The bird feed mixture of the invention may be produced in a method comprising combining nyjer, safflower, black oil sunflower, peanut, white millet, sunflower chips, canary seed, raisins, red millet, and juniper berries. The invention provides a method for repelling birds comprising supplying the bird feed mixture of the invention. The invention also provides a method for increasing desirable birds comprising supplying the bird feed mixture of the invention.

The following examples are not intended to limit the invention in any way.

### EXAMPLES

### Example 1

### Side-by-Side Comparison of MCB Mixture and Control

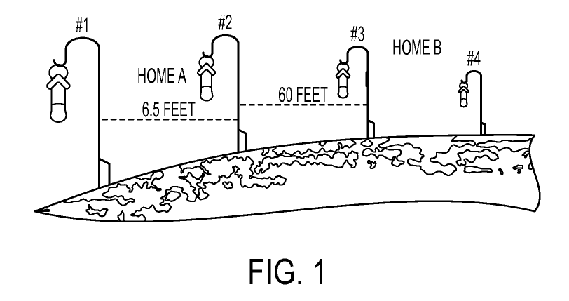

At multiple testing stations, sets of 4 bird feeders were established. The stations corresponded to a wide range of environmental habitats including riparian woodland edge, open landscaped areas, pond-side habitats, and woodland/agricultural habitats. The environmental habitats of the testing stations possessed varying vegetation, sound, topography, human presence, water access, animal disturbance and natural predators. At each station, two “homes” consisting of two bird feeders each were established. The arrangement of a station is illustrated in FIG. 1.

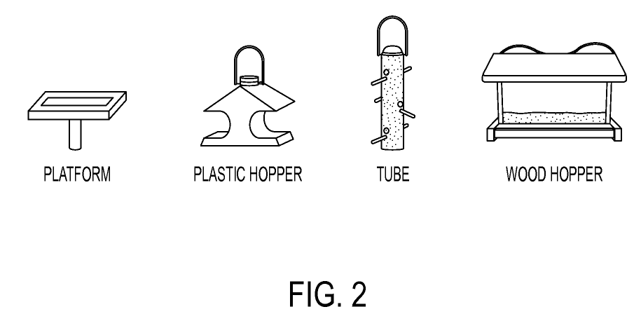

Each station had two different types of bird feeder (e.g., platform and tube feeders), but each home had matching types of birdfeeders. For example, Home A might have a platform bird feeder and a plastic tube feeder, in which case Home B would also have a platform bird feeder and a plastic tube feeder. Examples of some of the general types of bird feeders that could be used are shown in FIG. 2.

At each station, the two bird feeders at one of the Homes were filled with the MCB mixture composed of 20% nyjer (thistle), 18% safflower, 10% black oil sunflower, 10% peanut, 8% white millet, 8% sunflower chips, 8% canary seed, 8% raisin, 6% red millet, and 4% juniper berry by weight. The two bird feeders at the station's other Home were filled with a control bird feed mixture, Scotts® Ultimate Songbird Blend.

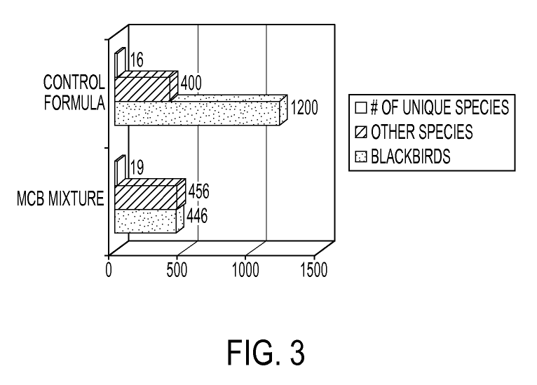

A side-by-side comparison test of the MCB mixture and the control mixture was conducted over the course of approximately two weeks. Over the course of the survey, 1,200 blackbirds, including the common grackle, red-winged blackbirds, and brown-headed cowbirds, were observed visiting bird feeders containing the control bird feed mixture. 400 visits by birds other than blackbirds were also made to bird feeders containing the control bird feed mixture. In contrast, only 446 blackbirds were observed visiting the bird feeders containing the MCB mixture. A total of 456 non-blackbird bird visits were made to bird feeders containing the MCB mixture. Additionally, 19 unique species were observed visiting the bird feeders containing the MCB mixture, while 16 unique species were observed visiting the bird feeders containing the control bird feed mixture. The results of this survey are shown in FIG. 3.

### Example 2

### Comparison of MCB Mixture and Control

At each of five testing stations arranged as shown in FIG. 1, all of the bird feeders in both “Homes” were filled with control formula bird feed. For a two-day period, the number of bird visits to the bird feeders by blackbirds and by other species were recorded. After a three-day break, all of the feeders were again filled, this time with the MCB mixture. For a two-day period the number of bird visits to the bird feeders by blackbirds and by other species were recorded. During both of the testing time periods, the number of pounds of bird feed consumed was monitored.

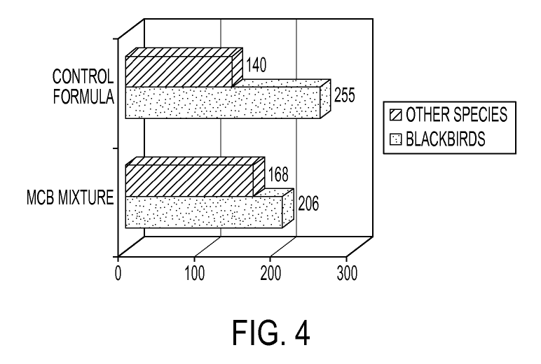

During the initial two-day testing period for the control formula bird feed, 140 non-blackbird bird visits to the feeders were observed. For the same time period, 255 blackbird visits to the bird feeders were observed. During the final two-day testing period for the MCB mixture, 168 non-blackbird bird visits to the feeders were observed. For the same time period, 206 blackbird visits to the bird feeders were observed. Thus, approximately 19% fewer blackbirds visited bird feeders containing the MCB mixture than visited bird feeders containing the control formula bird feed. Approximately 20% more desirable birds (i.e., non-blackbirds) visited bird feeders containing the MCB mixture than visited bird feeders containing the control formula bird feed. These results are shown in FIG. 4.

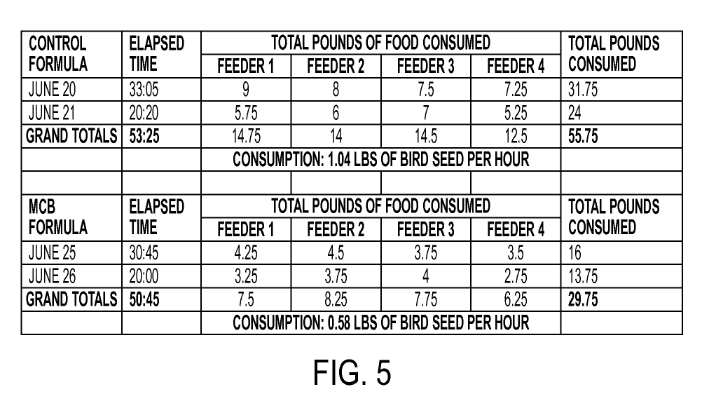

During the two testing time periods, the number of pounds of bird feed consumed was monitored. For the first testing period, in which the control formula bird feed was tested, there were 53 hours and 25 minutes of testing, during which time 55.75 pounds of control formula bird feed was consumed. This yields a consumption rate of 1.04 pounds of bird seed per hour. For the second testing period, in which the MCB mixture was tested, there were 50 hours and 45 minutes of testing, during which time 29.75 pounds of the MCB mixture bird feed was consumed. This yields a consumption rate of 0.58 pounds of bird seed per hour. These results are tabulated in FIG. 5.

### Example 3

### Side-by-Side Comparison of MCB Mixture and Control

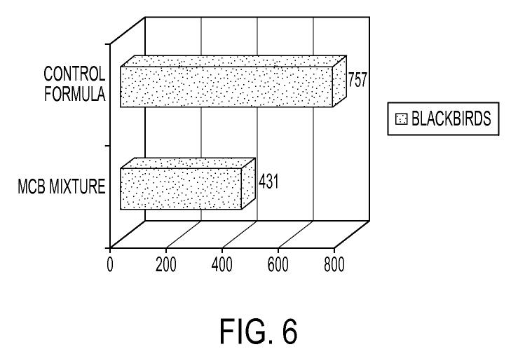

During a two-week testing period, two testing stations as shown in FIG. 1 were established. At each station, two bird feeders in one Home were filled with the MCB mixture, while two bird feeders in the other Home were filled with the control formula bird feed mixture. The number of blackbird visits to feeders containing the MCB mixture and the number of blackbird visits to feeders containing the control formula bird feed were observed. Over the course of the two-week testing period, 757 blackbird visits to bird feeders containing the control formula bird feed were observed. During the same period, 431 blackbird visits to bird feeders containing the MCB mixture were observed. Thus, some 43% fewer blackbird visits to feeders containing the MCB mixture were observed. These results are shown in FIG. 6.

### Example 4

### Optimization of the MCB Mixture

Additional testing was conducted at locations in Ohio and Louisiana. At each location, four bird feeders were established. The feeders were divided into two “Homes” consisting of two bird feeders each. Each of the bird feeders at a given Home was filled with bird food formulations containing mixtures of safflower, black oil sunflower, white millet, and thistle that made up 56% of the formulation and fixed proportions of sunflower seed chips (8%), peanut (10%), canary seed (8%), raisins (8%), red millet (6%), and juniper berries (4%) that made up the remaining 44% of the formulation. The various mixtures of safflower, black oil sunflower, white millet, and thistle are shown below in Table 1. The feeders were then observed for a six-week period in order to count and identify the birds that chose to visit each of the feeders.

TABLE 1

| | | BLACK OIL | WHITE | THISTLE |
|---|---|---|---|---|
| FORMU- | SAFFLOWER | SUNFLOWER | MILLET | (NYJER) |
| LATION | (%) | (%) | (%) | (%) |
| #1 (MCB) | 18 | 10 | 8 | 20 |
| #2 | 16 | 20 | 12 | 8 |
| #3 | 26 | 4 | 3 | 23 |
| #4 | 25 | 4 | 15 | 12 |
| #5 | 27 | 19 | 3 | 7 |
| #6 | 9 | 4 | 17 | 26 |
| #7 | 6 | 21 | 3 | 26 |
| #8 | 35 | 4 | 9 | 8 |
| #9 | 19 | 28 | 3 | 6 |
| #10 | 8 | 20 | 22 | 6 |
| #11 | 10 | 4 | 29 | 13 |
| #12 | 6 | 32 | 7 | 11 |

The testing at the two locations included over 20,000 individual feeder observations and over 19,500 individual birds counted at the feeders. The experimental data showed that formulations #2 and #9 performed significantly better than the MCB formulation at attracting fewer undesirable birds. Formulations #2 and #9 both contained (1) a moderate percentage of safflower, (2) a high percentage of black oil sunflower, and (3) low percentages of white millet and Nyjer (thistle). Regression analysis of the data collected at the two locations was used to calculate an optimum bird food formulation for attracting fewer undesirable birds of 16% safflower, 27% black oil sunflower, 7% white millet, and 6% Nyjer (thistle), with the fixed proportions of other ingredients as discussed above.

The data gathered from the two testing locations was also used to determine which of the formulations performed best at attracting non-blackbirds (i.e., desirable birds). Formulas 2, 3, 4, 6, 8, 10, 11, and 12 attracted significantly more non-blackbirds than the MCB formulation. In particular, Formulation #10 was very effective at attracting desirable birds. Regression analysis of the data was used to calculate an optimum bird food formulation for attracting non-blackbirds of 6% safflower, 21% black oil sunflower, 23% white millet, and 6% Nyjer (thistle), with the fixed proportions of other ingredients as discussed above. The calculated optimal formulation for attracting non-blackbirds and formulation #10 both contained (1) high levels of white millet, (2) high percentages of either safflower or black oil sunflower (but not both), and (3) low percentages of Nyjer (thistle).

Finally, the data was analyzed to determine an overall optimal formulation for maximizing the ratio of non-blackbirds to blackbirds. The overall optimum formulation was determined to be 31% safflower, 4% black oil sunflower, 15% white millet, and 6% Nyjer (thistle), with the fixed proportions of other ingredients as discussed above. This overall optimal formulation contains a high percentage of safflower and a low percentage of thistle.

Therefore, optimal formulas that maximize the ratio of non-blackbirds to blackbirds share the following characteristics: (1) low levels of Nyjer (6% or less); (2) moderate levels of white millet (between 11% and 21%); and (3) high levels of either safflower or sunflower seeds (but not both), with higher levels of safflower slightly preferred.

Although the foregoing invention has been described in some detail by way of illustration and example for purposes of clarity of understanding, it will be obvious that certain changes and modifications may be practiced within the scope of the appended claims. Modifications of the above-described modes for carrying out the invention that are obvious to persons of skill in art are intended to be within the scope of the following claims.

All publications and patents cited in this specification are herein incorporated by reference to the same extent as if each individual publication or patent was specifically and individually indicated to be incorporated by reference.

What is claimed is:

1. A bird feed mixture, wherein the bird feed mixture comprises about 0.1 to 30% nyjer, about 0.1 to 30% safflower, about 0.1 to 20% black oil sunflower, about 0.1 to 15% peanut, about 0.1 to 15% white millet, about 0.1 to 20% sunflower chips, about 0.1 to 15% canary seed, about 0.1 to 15% raisin, about 0.1 to 10% red millet and 0.1 to 10% juniper berry by weight, and wherein the bird feed mixture is not about 20% nyjer (thistle), about 18% safflower, about 10% black oil sunflower, about 10% peanut, about 8% white millet, about 8% sunflower chips, about 8% canary seed, about 8% raisin, about 6% red millet, and about 4% juniper berry by weight.

2. The bird feed mixture of claim 1, wherein the bird feed mixture comprises about 15 to 25% nyjer, about 14 to 22% safflower, about 7 to 13% black oil sunflower, about 7 to 13% peanut, about 6 to 10% white millet, about 6 to 10% sunflower chips, about 6 to 10% canary seed, about 6 to 10% raisin, about 4 to 8% red millet and about 3 to 5% juniper berry by weight.

3. The bird feed mixture of claim 1, wherein the bird feed mixture comprises about 18 to 22% nyjer, 16 to 20% safflower, 9 to 11% black oil sunflower, 9 to 11% peanut, 7 to 9% white millet, 7 to 9% sunflower chips, 7 to 9% canary seed, 7 to 9% raisin, 5 to 7% red millet, and 3 to 5% juniper berry by weight.

4. The bird feed mixture of claim 1, wherein the bird feed mixture comprises about 6% nyjer (thistle), about 16% safflower, about 27% black oil sunflower, about 10% peanut, about 7% white millet, about 8% sunflower chips, about 8% canary seed, about 8% raisin, about 6% red millet, and about 4% juniper berry by weight.

5. The bird feed mixture of claim 1, wherein the bird feed mixture comprises about 6% nyjer (thistle), about 6% safflower, about 21% black oil sunflower, about 10% peanut, about 23% white millet, about 8% sunflower chips, about 8% canary seed, about 8% raisin, about 6% red millet, and about 4% juniper berry by weight.

6. The bird feed mixture of claim 1, wherein the bird feed mixture comprises about 6% nyjer (thistle), about 31% safflower, about 4% black oil sunflower, about 10% peanut, about 15% white millet, about 8% sunflower chips, about 8% canary seed, about 8% raisin, about 6% red millet, and about 4% juniper berry by weight.

7. A container, item or packaged comprising the bird feed mixture of claim 1.

8. A method of producing the bird feed mixture of claim 1, comprising combining nyjer, safflower, black oil sunflower, peanut, white millet, sunflower chips, canary seed, raisin, red millet and juniper berry.
